(19) United States
(12) Patent Application Publication
(10) Pub. No.: US 2005/0089209 A1
(43) Pub. Date: Apr. 28, 2005

(54) Check and method of providing apriori reference image quality data for use in determining quality of an image of a financial document

(75) Inventor: Nancy B.M. Stefanuk, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 10/691,215

(22) Filed: Oct. 22, 2003

(51) Int. Cl. G06K 9/00

(52) U.S. Cl. 382/137

(57) ABSTRACT

A check made of sheet material has at least one field of pre-printed information. Apriori reference image quality data which is representative of at least one characteristic of the pre-printed information contained in the at least one field is stored on the sheet material check. Alternatively, a check made of sheet material has at least one encoded symbol disposed on the sheet material. Apriori reference image quality data which is representative of at least one characteristic of the encoded symbol is stored on the sheet material of the check.

### BACKGROUND OF THE INVENTION

The present invention relates to quality of financial document images, and is particularly directed to a check and a method of providing apriori reference image quality data for use in determining quality of an image of a financial document, such as a check.

In some check imaging applications, the quality of a check image may be of concern. For example, the quality of a check image may be of concern in a check truncation environment where a check image is electronically transferred from a sending bank to a receiving bank for check clearing purposes. In this type of check imaging application, the receiving bank wants to ensure that the electronically transferred check image is of sufficient quality for the intended use before accepting the check image from the sending bank. In another type of check imaging application, a bank may want to ensure that a check image is of sufficient quality before storing the check image in a check image archive. In still another type of check imaging application, a bank may want to ensure that a check image retrieved from a check image archive is of sufficient quality before printing the check image onto a letter to be sent to a bank customer.

A recognition engine may be used in known methods of determining quality of a check image. The recognition engine processes image data which is representative of an image of a check and makes a determination as to whether the quality of the check image is acceptable or not acceptable. Since checks vary greatly in design, format, layout, and content, it is sometimes difficult and problematic for a recognition engine to make the determination as to whether the quality of a check image is acceptable or not acceptable. At times, the recognition engine may have difficulty in locating a field of information to be recognized. At other times, the recognition engine has no difficulty in locating a field of information to be recognized, but may have difficulty in reading the information in the field. It would be desirable to simplify the tasks of a recognition engine which is used in determining the quality of financial document images, such as check images.

### SUMMARY OF THE INVENTION

In accordance with one aspect of the present invention, a check comprises sheet material, means defining at least one field of pre-printed information on the sheet material, and means for storing on the sheet material apriori reference image quality data which is representative of at least one characteristic of the pre-printed information contained in the at least one field.

In accordance with another aspect of the present invention, a check comprises sheet material, at least one encoded symbol disposed on the sheet material, and means for storing on the sheet material apriori reference image quality data which is representative of at least one characteristic of the encoded symbol.

In accordance with still another aspect of the present invention, a method of storing apriori reference image quality data which is representative of at least one characteristic of pre-printed information contained in at least one field of a check comprises storing the apriori reference image quality data on the check. The stored apriori reference image quality data may include data which is representative of the number of fields of pre-printed information on the check. The stored apriori reference image quality data for each field of pre-printed information may include data which is representative of content of the pre-printed information contained in the field, data which is representative of type of print contained in the field, format data which is representative of format of the pre-printed information in the field, data which is representative of physical dimensions of the field, or data which is representative of location of the field.

In accordance with yet another aspect of the present invention, a method of storing apriori reference image quality data which is representative of at least one characteristic of at least one encoded symbol disposed on a check comprises storing the apriori reference image quality data which is representative of the at least one characteristic of the encoded symbol on the check.

In accordance with another aspect of the present invention, a method of providing an indication of quality of an image of a financial document other than currency comprises storing on the financial document apriori reference image quality data which is representative of at least one characteristic of the financial document, receiving image data which is representative of the image of the financial document, retrieving the stored apriori reference image quality data, comparing the retrieved apriori reference image quality data with the image data which is representative of the image of the financial document, and providing an indication of quality of the image of the financial document based upon the comparison of the apriori reference image quality data with the image data. The at least one characteristic of the financial document may include a characteristic of the pre-printed information contained in at least one field of the financial document. The at least one characteristic of the financial document may include a characteristic of at least one encoded symbol on the financial document.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a representation of a typical check embodying the present invention and showing exemplary check fields which contain pre-printed check information;

FIG. 2 is a simplified schematic block diagram showing an image quality application program which embodies the present invention; and

FIG. 3 is a flowchart depicting the image quality application program of FIG. 2 for providing an indication of quality of the image of the check shown in FIG. 1.

### DETAILS OF THE INVENTION

The present invention is directed to a check and method of providing apriori reference image quality data for use in determining quality of a financial document image, such as a check image. The check may be of any type, such as a check of the personal type, a check of the business type, or a check of the government type.

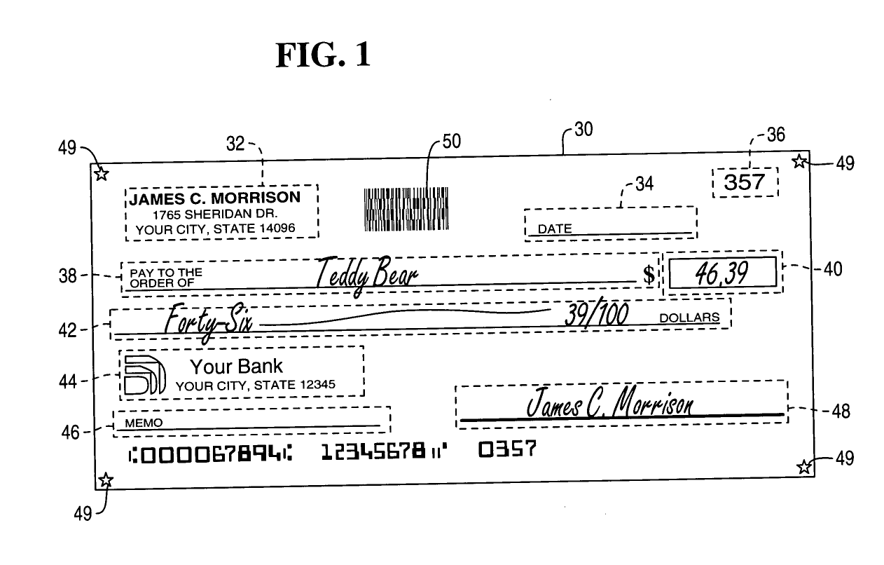

Referring to FIG. 1, a typical check 30 of the personal type is illustrated. The check 30 made of sheet material includes a payer field 32, a date field 34, a check number/routing & transit number field 36 located in the upper-right corner of the check, a payee field 38, a courtesy amount field 40, a legal amount field 42, a paying bank name field 44, a memo field 46, and a payer signature field 48. Each field of the check 30 contains pre-printed information therein, as shown in FIG. 1. A number of encoded symbols 49 is disposed on the sheet material of the check 30. Although there are four encoded symbols 49 shown in FIG. 1, it is contemplated that this number may be any number.

The check 30 also has an area of encoded information 50 which is pre-printed on the check. The encoded information 50 contains apriori reference image quality data which is representative of either at least one characteristic of the pre-printed information contained in at least one field of the check 30 or at least one characteristic of at least one encoded symbol on the check 30, or both. As shown in FIG. 1, the encoded information 50 is in the form of a two-dimensional barcode. Thus, the check 30 has a two-dimensional barcode which contains apriori reference image quality data which is representative of either at least one characteristic of the pre-printed information contained in at least one field of the check or at least one characteristic of at least one encoded symbol on the check, or both.

The at least one characteristic of the pre-printed information contained in the at least one field of the check 30 may include, for example, the number of fields having pre-printed information contained therein. Alternatively, each field of pre-printed information may have a number of characteristics associated therewith. For example, the characteristic(s) for each field of pre-printed information may include one or more of the following: type of print in the field, if any (OCR A/B/other, MICR E13B, MICR CMC7, constrained handprint, unconstrained handprint, etc.); format of the pre-printed information in the field (e.g., expected format of fields in a codeline); and content of the pre-printed information in the field (e.g., payor name and address, bank number, account number, check number).

The at least one characteristic of the pre-printed information contained in the at least one field of the check 30 may include alphanumeric text and/or lines, for example, which appear on the face of the check 30. The at least one characteristic may include alphanumeric text contained in the payer field 32, alphabetic text and a line contained in the date field 34, numeric text in the check number field 36, a line and alphabetic text including a dollar sign symbol in the payee field 38, lines forming the rectangle in the courtesy amount field 40, a line and alphabetic text in the legal amount field 42, alphanumeric text and a logo character in the paying bank name field 44, a line and alphabetic text in the memo field 46, and a relatively thicker line in the payer signature field 48. The alphanumeric text, characters, and/or lines contained in the different fields 32, 34, 36, 38, 40, 42, 44, 46, 48 of the check 30 are also exemplary of the type of pre-printed information which is represented by the encoded apriori reference image quality data 50 which has been pre-printed on the check.

The above list of characteristics for each field of pre-printed information is exemplary only and, therefore, other characteristics are possible. It is contemplated that a set of characteristics associated with one field of pre-printed information may be different from a set of characteristics associated with another field of pre-printed information, or that some field(s) of pre-printed information may have no characteristic which is represented by apriori reference image quality data contained in the two-dimensional barcode 50. Also, it is contemplated that the encoded information 50 may contain data which is representative of location of the origin of at least one field and dimensions (length/height) of the at least one field. This data is useful to a recognition engine in quickly locating the at least one field.

The at least one characteristic of the encoded symbols 49 on the check 30 may include location and content, for example, of the encoded symbols. Since the bank issued the check 30 to its customer, the bank has apriori knowledge as to the location and content of the encoded symbols 49 and/or the alphanumeric text, characters, and/or lines contained in the different fields 32, 34, 36, 38, 40, 42, 44, 46, 48 of the check 30, as well as the specific location of the fields on the check. Before the bank issues a book of checks including the check 30 to the customer, the corresponding encoded apriori reference image quality data for each check is pre-printed onto that particular check in the checkbook. Thus, for each check, encoded apriori reference image quality data which is representative of either characteristics of the pre-printed information contained in a number of fields of the particular check or characteristics of a number of encoded symbols on the particular check, or both, is pre-printed on that check.

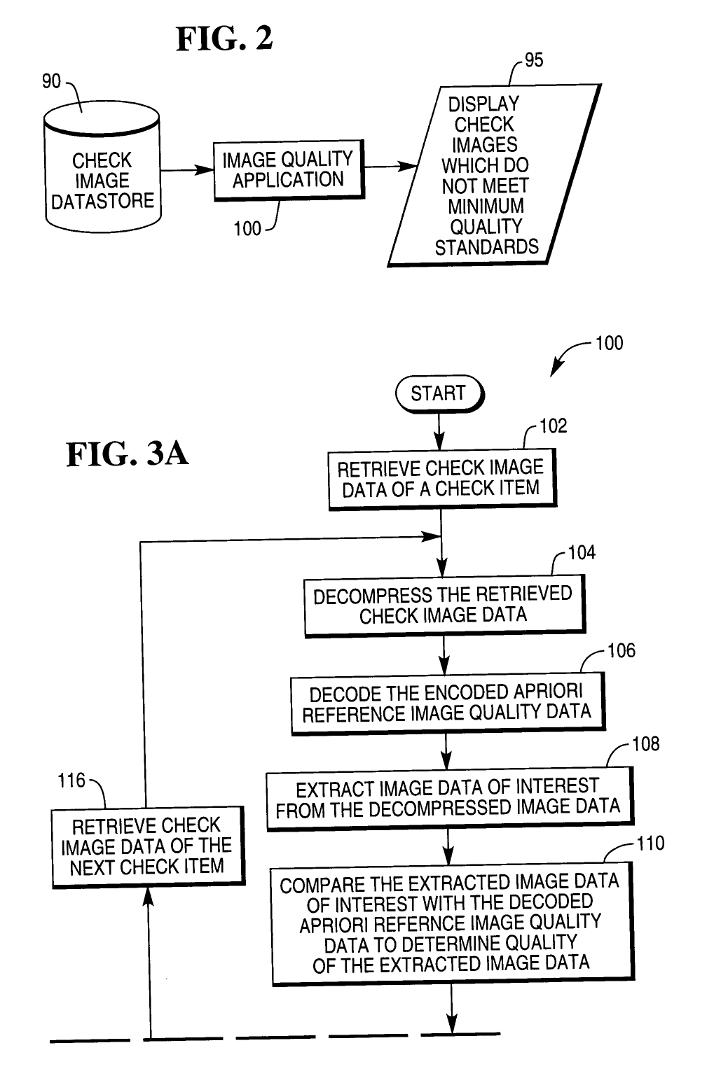

Referring to the simplified schematic block diagram of FIG. 2, an image quality application program 100 embodying the present invention is illustrated. The image quality application program 100 retrieves check image data from a check image datastore 90. The check image datastore 90 may comprise a temporary data storage device, for example. As another example, the check image datastore 90 may comprise a check image data archive. The check image data is representative of images of a number of checks. The image quality application program 100 then processes the check image data to determine quality of the check images. Check images which did not meet minimum quality standards are presented on a display 95 to allow an operator to view the check images.

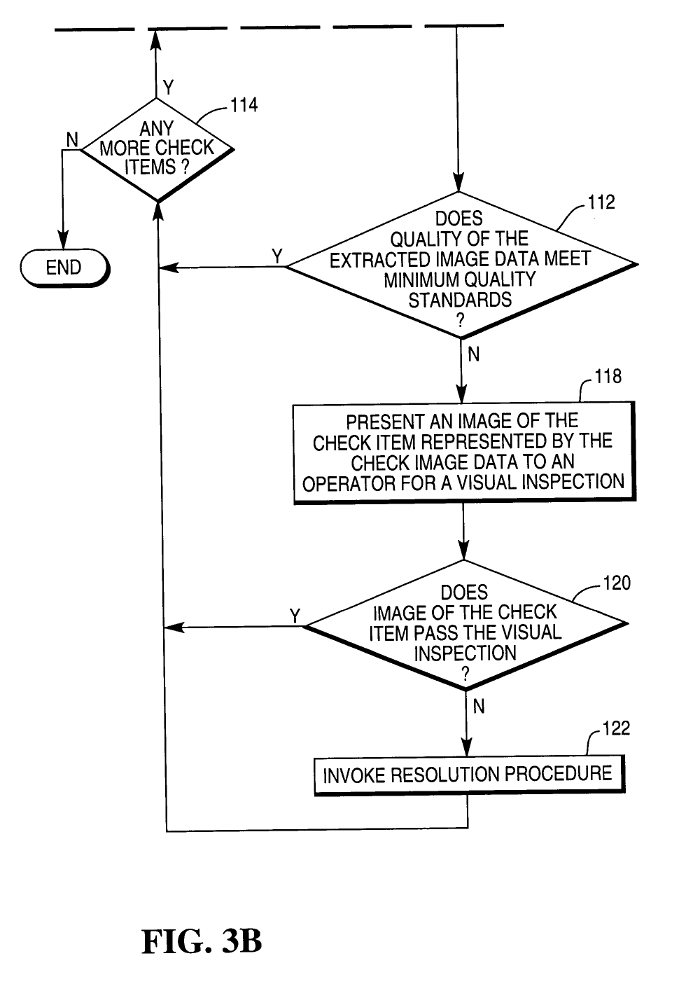

Referring to FIG. 3, a flowchart depicts operation of the process carried out by the image quality application program 100 to determine if check images are of acceptable quality for their intended use. After retrieving from the check image datastore 90 check image data which corresponds to the present check (such as the check 30 shown in FIG. 1) being processed, as shown in step 102, the program proceeds to step 104 in which the retrieved check image data is decompressed in a known manner. Then, in step 106, the encoded apriori reference image quality data 50 which has been pre-printed on the check 30 is decoded using a two-dimensional barcode reader. Two-dimensional barcode readers are well known and, therefore, will not be described. The encoded apriori reference image quality data 50 pre-printed on the check 30 is representative of characteristics of the pre-printed information contained in a number of fields of the check when the check was issued by the issuing bank to its customer, as previously discussed.

The program proceeds to step 108 in which certain check image data of interest is extracted from the decompressed image data. Then, in step 110, the extracted image data of interest is compared with the apriori reference image quality data which has been decoded in step 106. There are many ways in which the comparison in step 110 may be accomplished. For example, the comparison may involve determining if the type of print in a field is of a certain type of print. As another example, the comparison may involve determining if text in a field is in a certain type of format (e.g., alphabetic, numeric, or alphanumeric; left justified or right justified; and single line or multiple lines). Alternatively, the comparison may involve determining if text is readable. Still as another example, the comparison may involve determining if content of the pre-printed information in a field matches content represented by the apriori reference image quality data which has been decided in step 106.

Anther comparison may involve determining if a line is of a predetermined thickness, such as the relatively thicker line in the payer signature field 48. Still another comparison may involve determining if there is a break in a line and/or text by examining pixels. Yet another comparison may involve determining location and content of specially encoded symbols, such as the encoded symbols 49 shown in FIG. 1, to be used for image quality analysis. If the encoded symbols 49 are found in the check image, then the check image could be considered a full image of the check.

Based upon the comparison in step 110, a determination is made in step 112 as to whether the quality of the extracted image data of interest meets minimum quality standards. If the determination in step 112 is affirmative, the program proceeds to step 114 to determine if there are any more check items to be processed. If the determination in step 114 is negative, the program terminates. Otherwise, the program proceeds to step 116 in which check image data which represents the check image of the next check item is retrieved from the check image datastore 90. The program returns to step 104 to process this next check item in the same manner as the previous check item as just described hereinabove.

However, if the determination in step 112 is negative, the program proceeds to step 118 in which an image of the check represented by the check image data is presented on the display 95 for allowing an operator to visually inspect the check image. Then, in step 120, if the operator determines that the image of the check passes the visual inspection, then the program proceeds to step 1 14 to determine if there are any more check items to be processed. If the determination in step 114 is negative, the program terminates. Otherwise, the program proceeds to step 116 in which check image data which represents the check image of the next check is retrieved from the check image datastore 90. The program returns to step 104 to process this next check in the same manner as the previous check as just described hereinabove.

If the operator in step 120 determines that the image of the check does not pass the visual inspection, the program proceeds to step 122 in which a resolution procedure is invoked to determine what next steps are needed. The resolution procedure followed will depend upon the particular processes of the particular bank. In certain instances, for example, someone of higher authority at the bank may determine the check image to be acceptable even though the check image did not pass the earlier visual inspection by an operator. The resolution procedure followed will depend upon the specific processes of the receiving bank and will differ from bank to bank. The program then proceeds to step 114 to determine if there are any more checks to be processed. If the determination in step 114 is negative, the program terminates. Otherwise, the program proceeds to step 116 in which the next check is retrieved from the check image datastore 54. The program returns to step 104 to process this next check in the same manner as the previous check as just described hereinabove.

It should be apparent that the above description describes a process in which a bank can, with minimum human intervention, establish the quality of check images of checks. For those check images which do not meet the minimum quality standards set forth by the bank or by industry standards, for example, the check images may then be forwarded to an operator for a visual inspection by the operator.

It is contemplated that the bank may have received the check images from another bank, or the bank may have retrieved the check images from a check image datastore such as a check image archive, for example. These different check imaging applications are only exemplary applications embodying the present invention. It is contemplated that the present invention may be embodied in any type of application where quality of a document image is of concern. Also, it is contemplated that the document may be any type of document other than currency.

Although the above description describes that the encoded information 50 is in the form of a two-dimensional barcode, it is contemplated that the encoded information may take other forms. For example, the encoded information may take the form of a one-dimensional barcode. Other examples include PDF417, Code One, DataMatrix, and Xerox Dataglyph.

It is also contemplated that one or more characteristics of the form of the encoded information may be used for the purpose of establishing quality of the image of the check. For example, in the case of the two-dimensional barcode, it is conceivable that the image of the barcode could be used to test the focus of the barcode image. It is also conceivable that the image of the two-dimensional barcode could be used to test the sharpness of the barcode image.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A check comprising:
sheet material;
means defining at least one field of pre-printed information on the sheet material; and
means for storing on the sheet material apriori reference image quality data which is representative of at least one characteristic of the pre-printed information contained in the at least one field.

2. A check comprising:
sheet material;
at least one encoded symbol disposed on the sheet material; and
means for storing on the sheet material apriori reference image quality data which is representative of at least one characteristic of the encoded symbol.

3. A method of storing apriori reference image quality data which is representative of at least one characteristic of pre-printed information contained in at least one field of a check, the method comprising:
storing the apriori reference image quality data on the check.

4. A method according to claim 3, wherein the stored apriori reference image quality data includes data which is representative of the number of fields of pre-printed information on the check.

5. A method according to claim 4, wherein the stored apriori reference image quality data for each field of pre-printed information includes data which is representative of content of the pre-printed information contained in the field.

6. A method according to claim 3, wherein the stored apriori reference image quality data for each field of pre-printed information includes data which is representative of type of print contained in the field.

7. A method according to claim 3, wherein the stored apriori reference image quality data for each field of pre-printed information includes format data which is representative of format of the pre-printed information in the field.

8. A method according to claim 3, wherein the stored apriori reference image quality data for each field of pre-printed information includes data which is representative of physical dimensions of the field.

9. A method according to claim 3, wherein the stored apriori reference image quality data for each field of pre-printed information includes data which is representative of location of the field.

10. A method of storing apriori reference image quality data which is representative of at least one characteristic of at least one encoded symbol disposed on a check, the method comprising:
storing the apriori reference image quality data which is representative of the at least one characteristic of the encoded symbol on the check.

11. A method of providing an indication of quality of an image of a financial document other than currency, the method comprising:
storing on the financial document apriori reference image quality data which is representative of at least one characteristic of the financial document;
receiving image data which is representative of the image of the financial document;
retrieving the stored apriori reference image quality data;
comparing the retrieved apriori reference image quality data with the image data which is representative of the image of the financial document; and
providing an indication of quality of the image of the financial document based upon the comparison of the apriori reference image quality data with the image data.

12. A method according to claim 11, wherein the at least one characteristic of the financial document includes a characteristic of the pre-printed information contained in at least one field of the financial document.

13. A method according to claim 11, wherein the at least one characteristic of the financial document includes a characteristic of at least one encoded symbol on the financial document.
